(19) United States
(12) Patent Application Publication
(10) Pub. No.: US 2022/0399781 A1
(43) Pub. Date: Dec. 15, 2022

(54) MOTOR MODULE AND ELECTRIC POWERED TOOL USING THE SAME

(71) Applicant: Zhaojun Shi, Dongguan City, Guangdong Province (CN)

(72) Inventors: Zhaojun Shi, Dongguan City, Guangdong Province (CN); Canquan Huang, Dongguan City, Guangdong Province (CN)

(21) Appl. No.: 17/764,550

(22) PCT Filed: Apr. 1, 2021
(86) PCT No.: PCT/CN2021/084883

§ 371 Date: Mar. 29, 2022

(30) Foreign Application Priority Data
Apr. 11, 2020 (CN) 202020528226.X
Nov. 17, 2020 (CN) 202022662941.5

(51) Int. Cl. H02K 7/14; H02K 11/33; B25B 21/02; B25B 23/00

(52) U.S. Cl. CPC H02K 7/145; H02K 11/33; B25B 21/02; B25B 23/00

(57) ABSTRACT

A motor module and an electric powered tool using the motor module, which comprises: a motor, a cooling fan mounted on the rotor of the motor, and a control circuit board to control the motor, wherein, the cooling fan is located between the motor and the impact output module. In the present invention, the cooling fan is configured on the front end of the motor, and the control circuit board is configured on the rear end of the motor, thus the rotary shaft of the motor does not need to go through the control circuit board. Therefore, the control circuit board does not need to provide a through hole for the rotary shaft to go through, and the control circuit board can have a larger area.

### BACKGROUND OF INVENTION

### 1. Field of the Invention

The present invention relates generally to the field of motor, and more particularly to a motor module and an electric powered tool using the motor module.

### 2. Description of Related Art

A motor is a device used to convert electrical energy into mechanical energy. It uses an electrical coil (i.e., stator winding) to generate a revolving magnetic field to act on the rotor (i.e., a squirrel-cage closed aluminum frame) to generate an electromagnetic rotary torque. Based on different power sources, motors can be divided into DC motors and AC motors. Most motors in power systems are AC motors, which include synchronous motors and non-synchronous motors (the magnetic rotational speed of the stator is not synchronous with the rotational speed of the rotor). A motor mainly comprises a stator and a rotor. The movement direction of the electrical wires in the magnetic field is in connection with the direction of the electric current and the direction of the magnetic Field. The operating principle of a motor is that the magnetic field will generate a force to act upon an electrified conductor, which drives the motor.

In view of this, the inventor proposes the following technical solution.

### SUMMARY OF THE INVENTION

The purpose of the present invention is to overcome the deficiencies of the prior art, and to provide a motor module and an electric tool using the motor module.

In order to solve the above-mentioned technical problems, the present invention adopts the following technical solutions:

A motor module, comprising: a motor (1), a cooling fan (2) mounted on a rotor (11) of the motor (1), and a control circuit board (3) to control the motor (1), wherein, the cooling fan (2) is located between the motor (1) and the impact output module (5).

More particularly, a stator (12) sleeved on the rotor (11) and capable of relative rotation, and a radiator (13) mounted on one end of the stator (12), wherein, the control circuit board (3) is mounted on the radiator (13).

More particularly, wherein, the periphery of the stator (12) is evenly distributed with a plurality of threaded connection portions (120) for mounting the radiator (13), the radiator (13) is connected to the threaded connection portions (120) on one end of the stator (12) through, a plurality of bolts (10), and the bolts (10) go through the radiator (13).

More particularly, wherein the stator (12) comprises a coil frame (121), a coil mounted inside the coil frame (121), a first covering plate (122) configured on one end of the coil frame (121), and a second covering plate (123) configured on the other end of the coil frame (121), the threaded connection portions (120) are configured on the first covering plate (122) or the second covering plate (123).

More particularly, wherein the rotor (11) comprises a rotary shaft (111) going through the center of the coil frame (121), a magnet frame (112) sleeved on the rotary shaft (111) and located inside the coil frame (121), a magnet (118) installed inside the magnet frame (112), and a third covering plate (113) and a fourth covering plate (114) configured on the two sides of the magnet frame (112).

More particularly, wherein the control circuit board (3) is not configured with a Hall sensor.

More particularly, wherein the control circuit board (3) and the radiator (13) are configured on the rear end of the motor (1), the cooling fan (2) is configured on the front end of the motor (1), the threaded connection portions (120) are integrally formed on the first covering plate (122) or the second covering plate (123); the radiator (13) is configured with a first bearing (117) to support the rotor (11), and the rotor (11) does not go through the control circuit board (3).

More particularly, the control circuit board (3) and the radiator (13) are configured on the front end of the motor (1), the cooling fan (2) is configured on the rear end of the motor (1), the rotor (11) goes through the control circuit board (3) and the radiator (13); the threaded connection portions (120) are nuts mounted on the first covering plate (122) or the second covering plate (123).

More particularly, An electric powered tool having the motor module defined in claim 7, which comprises: a shell (4), a motor module (100) mounted inside the shell (4), an impact output module (5) mounted inside the shell (4) and driven by the motor module (100), a cell module (6) mounted inside the shell (4), a trigger (401) to start the operation of the motor module (100), and an illumination light (402) located beside the impact output module (5), wherein, the shell (4) comprises an operating portion (41) for mounting the motor module (100) and the impact output module (5), and a handhold portion (42) mounted on the cell module (6) to facilitate hand holding, and the trigger (401) and the illumination light (402) are configured at the junction between the operating portion (41) and the handhold portion (42).

More particularly, An electric powered tool having the motor module defined in claim 8, which comprises: a shell (4), a motor module (100) mounted inside the shell (4), an impact output module (5) mounted inside the shell (4) and driven by the motor module (100), a cell module (6) mounted inside the shell (4), a trigger (401) to start the operation of the motor module (100), and an illumination light (402) located beside the impact output module (5), wherein, the shell (4) comprises an operating portion (41) for mounting the motor module (100) and the impact output module (5), and a handhold portion (42) mounted on the cell module (6) to facilitate hand holding, and the trigger (401) and the illumination light (402) are configured at the junction between the operating portion (41) and the handhold portion (42).

Comparing to the prior art, the present invention has the following effects and benefits:

1. In the present invention, a cooling fan is configured on the front end of the motor, and a control circuit board is configured on the rear end of the motor. Thus the rotary shaft of the motor does not need to go through the control circuit board. Therefore, the control circuit board does not need to provide a through hole for the rotary shaft to go through, the control circuit board can have larger area, and the electronic components mounted on the control circuit board can me more sparse so that the control circuit board can have better heat radiation.

2. Nuts are embedded in the second covering plate in a detachable manner. Thus, during operation, the radiator and the second covering plate can have more stable connection. Moreover, as metal nuts are used as connectors, the durability can be longer and the nuts and bolts can be replaced easily.

### BRIEF DESCRIPTION OF THE DRAWINGS

FIG. 1 is a perspective view of Embodiment 1 of the present invention;

FIG. 2 is a main view of Embodiment 1 of the present invention;

FIG. 3 is an exploded view of Embodiment 1 of the present invention;

FIG. 4 is an exploded view of the rotor of the present invention;

FIG. 5 is a perspective view of Embodiment 2 of the present invention;

FIG. 6 is a main view of Embodiment 2 of the present invention;

FIG. 7 is an exploded view of Embodiment 3 of the present invention;

FIG. 8 is an exploded view of Embodiment 4 of the present invention;

FIG. 9 is a perspective view of Embodiment 3 of the present invention;

### DETAILED DESCRIPTION OF THE INVENTION

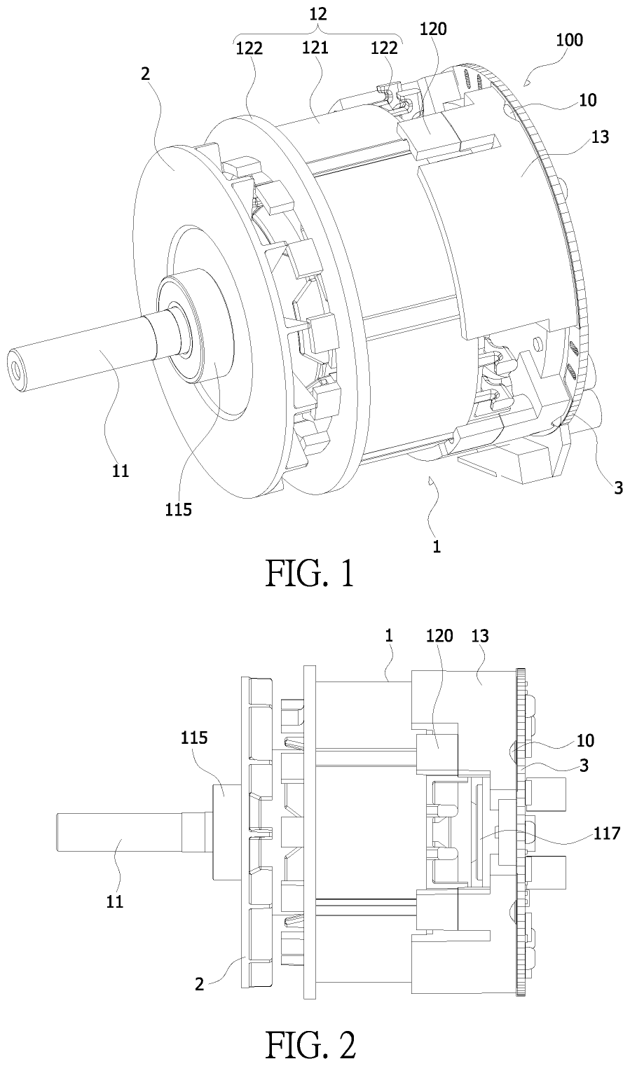

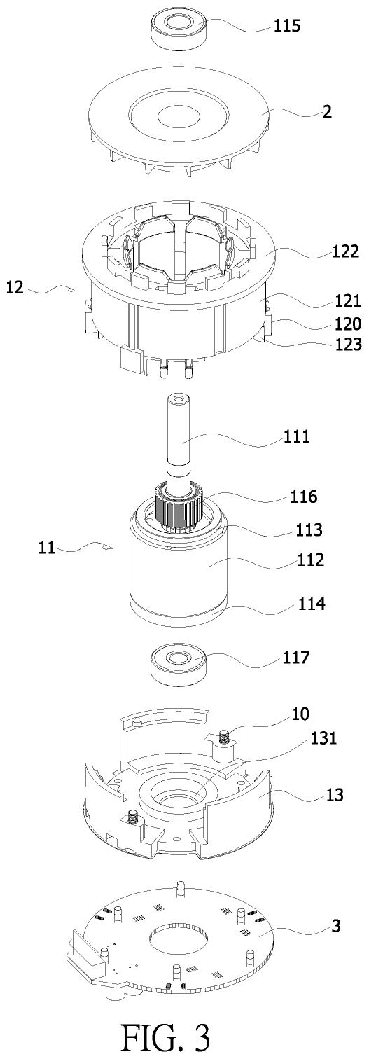

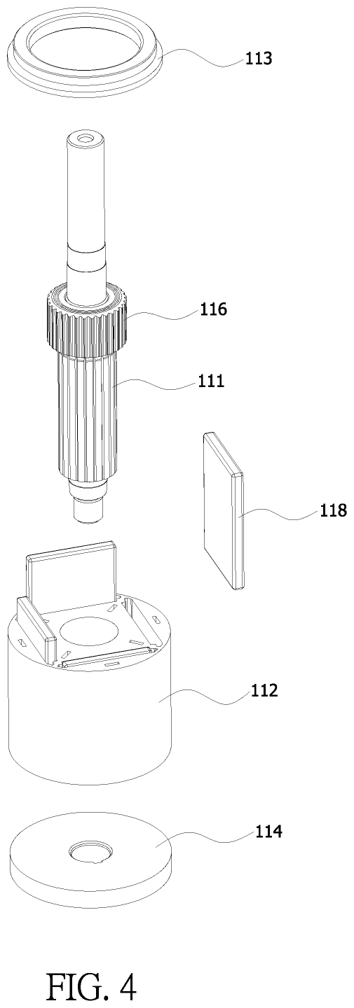

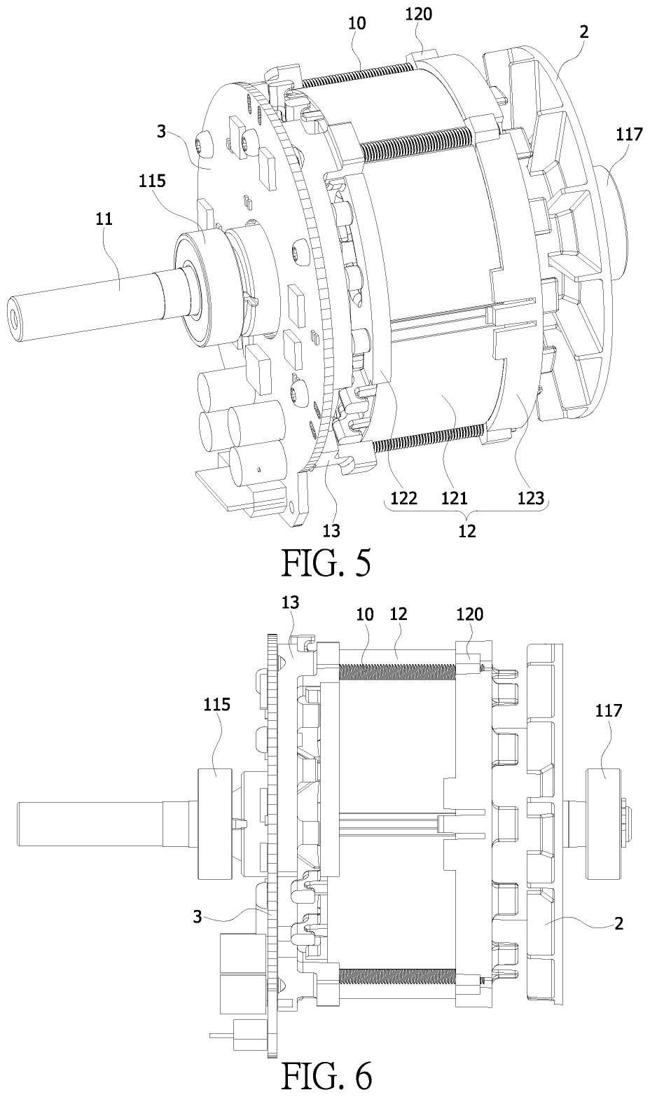

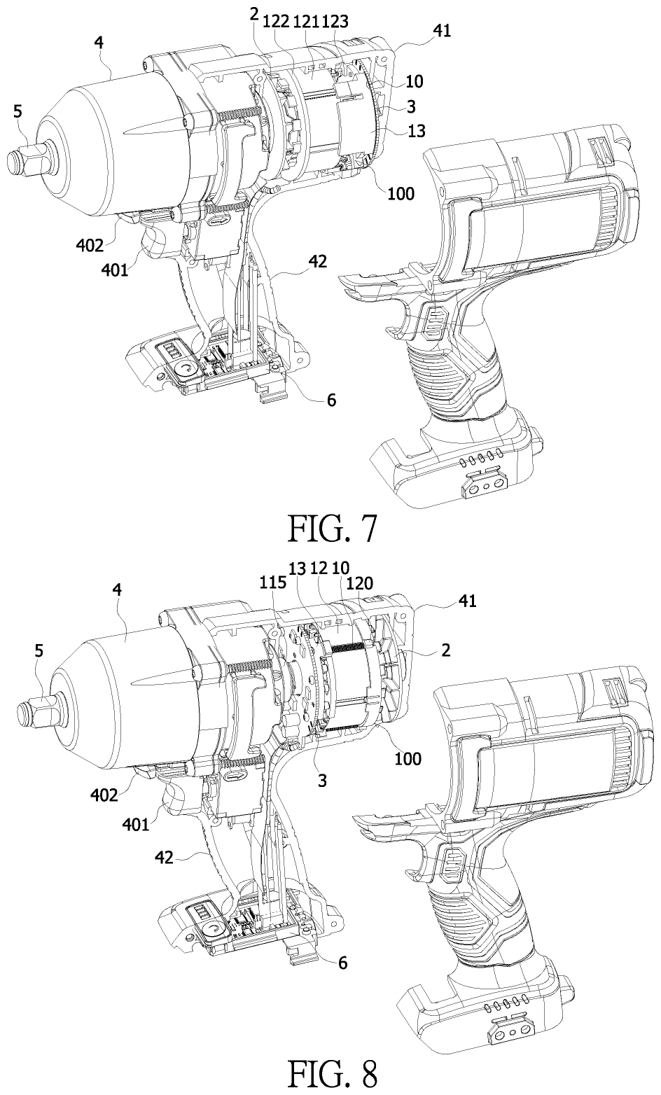

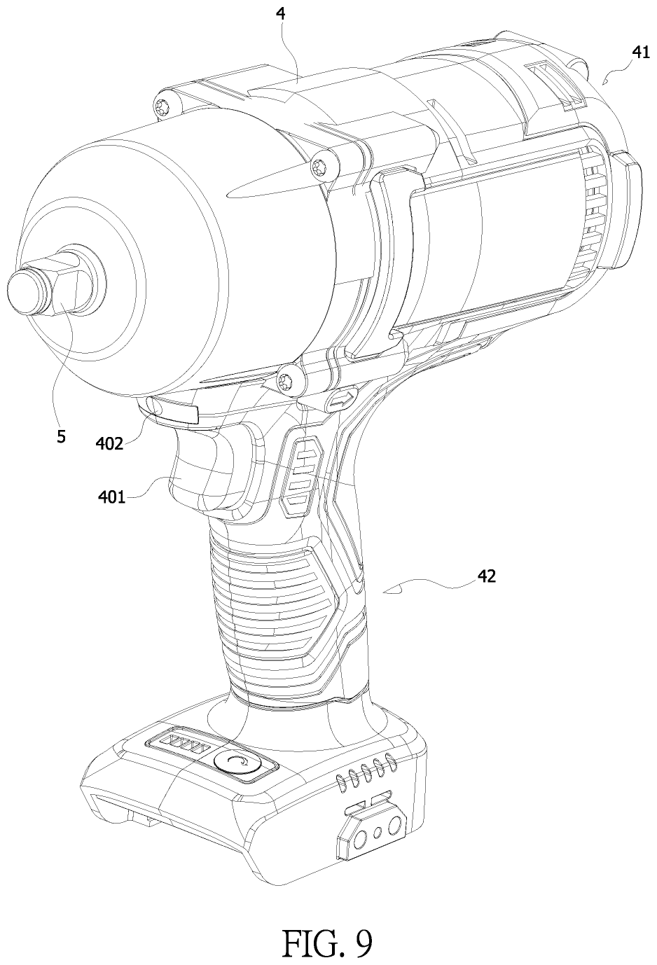

Disclosed in FIG. 1 to FIG. 9 is a motor module, which characteristically comprises: a motor 1, a cooling fan 2 mounted on the rotor 11 of the motor 1, and a control circuit board 3 to control the operation of the motor 1, wherein, the cooling fan 2 is located between the motor 1 and the impact output module 5.

The motor 1 comprises a rotor 11, a stator 12 sleeved on the rotor 11 and capable of relative rotation, and a radiator 13 mounted on the one end of the stator 12, wherein, the control circuit board 3 is mounted on the radiator 13. The control circuit board 3 is mounted on the motor 1 through the radiator 13, thus all the heat generated by the motor 1 and the control panel 3 can be radiated. Then, the cooling fan 2 turns together with the rotor 11 to generate air flow to remove the heat in the radiator 13, Such a configuration can enhance the efficiency of heat radiation and can avoid overheating of the motor 1 and the control circuit board 3.

The periphery of the stator 12 is evenly distributed with a plurality of threaded connection portions 120 for mounting the radiator 13. The radiator 13 is connected to the threaded connection portions 120 on one end of the stator 12 through a plurality of bolts 10. The bolts 10 go through the radiator 13.

The stator 12 comprises a coil frame 121, a coil mounted inside the coil frame 121, a first covering plate 122 configured on one end of the coil frame 121 and a second covering plate 123 configured on the other end of the coil frame 121. The threaded connection portions 120 are configured on the first covering plate 122 or the second covering plate 123.

The rotor 11 comprises a rotary shaft 111 going through the center of the coil frame 121, a magnet frame 112 sleeved on the rotary shaft 111 and located inside the coil frame 121, a magnet 118 installed inside the magnet frame 112, and a third covering plate 113 and a fourth covering plate 114 configured on the two sides of the magnet frame 112.

The control circuit hoard 3 is not configured with a Hall sensor. The present invention uses a back-electromotive force induction zone to replace the Hall sensor for detection of the location of the rotor. Back-electromotive force means an electromotive force resisting the tendency of current change, and is referred to as sensorless control.

Embodiment 1: The control circuit board 3 and the radiator 13 are configured on the rear end of the motor 1. The cooling fan 2 is configured on the front end of the motor 1. The threaded connection portions 120 are integrally formed on the first covering plate 122 or the second covering plate 123. The radiator 13 is configured with a first bearing 117 to support the rotor 11, and the rotor 11 does not go through the control circuit board 3. The radiator 13 is configured with a bearing hole 131 for installing the first bearing 117. The front end of the rotor 11 is configured with a second bearing 115. The second bearing 115 is located at the front end of the cooling fan 2. The first bearing 117 and the second bearing 115 are mounted on the rotary shaft 111, and are respectively located on the two sides of the magnet frame 112. The cooling fan 2 is mounted on the rotor 11 through a spline 116.

In Embodiment 1, the cooling fan 2 is configured on the front end of the motor 1, and the control circuit board 3 is configured on the rear end of the motor 1. Thus, the rotary shaft 11 of the motor 1 does not need to go through the control circuit board 3. Therefore, the control circuit board 3 does not need to provide a through hole for the rotary shaft 11 to go through, and the control circuit board 3 can have a larger area. As a result, electronic components mounted on the control circuit board 3 can be more sparse and the control circuit board 3 can have better heat radiation.

Embodiment 2: The control circuit board 3 and the radiator 13 are configured on the front end of the motor 1. The cooling fan 2 is configured on the rear end of the motor 1. The rotor 11 goes through the control circuit board 3 and the radiator 13. The threaded connection portions 120 are nuts mounted on the first covering plate 122 or the second covering plate 123. The two ends of the rotor 11 are respectively configured with a first bearing 117 and a second bearing 115. In the present embodiment, the nuts are mounted on the second covering plate 123, and the second covering plate 123 is configured with polygonal holes matching the nuts.

In Embodiment 2, nuts are embedded in the second covering plate 123 in a detachable manner. Thus, during operation, the radiator 13 and the second covering plate 123 can have more stable connection. Moreover, as metal nuts are used as connectors, the durability can be longer and the nuts and bolts can be replaced easily.

Embodiment 3: An electric powered tool that comprises: a shell 4, a motor module 100 mounted inside the shell 4, an impact output module 5 mounted inside the shell 4 and driven by the motor module 100, a cell module 6 installed inside the shell 4, a trigger 401 to start the operation of the motor module 100, and an illumination light 402 located beside the impact output module 5, wherein, the shell 4 comprises an operating portion 41 for mounting the motor module 100 and the impact output module 5, and a handhold portion 42 for installing the cell module 6 and for hand-holding. The trigger 401 and the illumination light 402 are configured at the junction between the operating portion 41 and the handhold portion 42.

Embodiment 4: An electric powered tool that comprises: a shell 4, a motor module 100 mounted inside the shell 4, an impact output module 5 mounted inside the shell 4 and driven by the motor module 100, a cell module 6 installed inside the shell 4, a trigger 401 to start the operation of the motor module 100, and an illumination light 402 located beside the impact output module 5, wherein, the shell 4 comprises an operating portion 41 for mounting the motor module 100 and the impact output module 5 and a handhold portion 42 for installing the cell module 6 and for hand-holding. The trigger 401 and the illumination light 402 are configured at the junction between the operating portion 41 and the handhold portion 42.

We claim:

1. A motor module, comprising:
a motor (1), a cooling fan (2) mounted on a rotor (11) of the motor (1), and a control circuit board (3) to control the motor (1), wherein the cooling fan (2) is located between the motor (1) and an impact output module (5).

2. The motor module defined in claim 1, wherein the motor (1) includes a rotor (11), a stator (12) sleeved on the rotor (11) and capable of relative rotation, and a radiator (13) mounted on one end of the stator (12), wherein the control circuit board (3) is mounted on the radiator (13).

3. The motor module defined in claim 2, wherein the periphery of the stator (12) is evenly distributed with a plurality of threaded connection portions (120) for mounting the radiator (13), the radiator (13) is connected to the threaded connection portions (120) on one end of the stator (12) through a plurality of bolts (10), and the bolts (10) go through the radiator (13).

4. The motor module defined in claim 3, wherein the stator (12) comprises a coil frame (121), a coil mounted inside the coil frame (121), a first covering plate (122) configured on one end of the coil frame (121), and a second covering plate (123) configured on the other end of the coil frame (121), the threaded connection portions (120) are configured on the first covering plate (122) or the second covering plate (123).

5. The motor module defined in claim 4, wherein the rotor (11) comprises a rotary shaft (111) going through the center of the coil frame (121), a magnet frame (112) sleeved on the rotary shaft (111) and located inside the coil frame (121), a magnet (118) installed inside the magnet frame (112), and a third covering plate (113) and a fourth covering plate (114) configured on the two sides of the magnet frame (112).

6. The motor module defined in claim 5, wherein the control circuit board (3) is not configured with a Hall sensor.

7. The motor module defined in claim 4, wherein the control circuit board (3) and the radiator (13) are configured on the rear end of the motor (1), the cooling fan (2) is configured on the front end of the motor (1), the threaded connection portions (120) are integrally formed on the first covering plate (122) or the second covering plate (123); the radiator (13) is configured with a first bearing (117) to support the rotor (11), and the rotor (11) does not go through the control circuit board (3).

8. The motor module defined in claim 4, the control circuit board (3) and the radiator (13) are configured on the front end of the motor (1), the cooling fan (2) is configured on the rear end of the motor (1), the rotor (11) goes through the control circuit board (3) and the radiator (13); the threaded connection portions (120) are nuts mounted on the first covering plate (122) or the second covering plate (123).

9. An electric powered tool having the motor module defined in claim 7, which comprises: a shell (4), a motor module (100) mounted inside the shell (4), an impact output module (5) mounted inside the shell (4) and driven by the motor module (100), a cell module (6) mounted inside the shell (4), a trigger (401) to start the operation of the motor module (100), and an illumination light (402) located beside the impact output module (5), wherein, the shell (4) comprises an operating portion (41) for mounting the motor module (100) and the impact output module (5), and a handhold portion (42) mounted on the cell module (6) to facilitate hand holding, and the trigger (401) and the illumination light (402) are configured at the junction between the operating portion (41) and the handhold portion (42).

10. An electric powered tool having the motor module defined in claim 8, which comprises: a shell (4), a motor module (100) mounted inside the shell (4), an impact output module (5) mounted inside the shell (4) and driven by the motor module (100), a cell module (6) mounted inside the shell (4), a trigger (401) to start the operation of the motor module (100), and an illumination light (402) located beside the impact output module (5), wherein, the shell (4) comprises an operating portion (41) for mounting the motor module (100) and the impact output module (5), and a handhold portion (42) mounted on the cell module (6) to facilitate hand holding, and the trigger (401) and the illumination light (402) are configured at the junction between the operating portion (41) and the handhold portion (42).
